(19) United States
(12) Patent Application Publication
(10) Pub. No.: US 2002/0147042 A1
(43) Pub. Date: Oct. 10, 2002

(54) System and method for detecting the result of a game of chance

(75) Inventors: Binh Thanh Vuong, Simi Valley, CA (US); Vinh Thanh Vuong, Simi Valley, CA (US); Liem Thanh Vuong, Simi Valley, CA (US); Son Thanh Vuong, Vancouver (CA); Craig Edward Shinners, Pasadena, CA (US)

Correspondence Address: Craig E. Shinners, Suite 610, 301 East Colorado Blvd., Pasadena, CA, 91101, US

(73) Assignee: VT TECH Corp.

(21) Appl. No.: 09/782,833

(22) Filed: Feb. 14, 2001

(51) Int. Cl. G06F 17/00

(52) U.S. Cl. 463/40

(57) ABSTRACT

The present invention relates to a system and method for detecting the outcome of a game of chance in a casino. The system comprises an intelligent table adapted for playing a game of chance and a interface manager for interfacing the table to a communications network and detectable gaming objects. Gaming objects, such as cards, die, chips, tokens or roulette ball are programmed with a unique value that may be selectively detected by the intelligent table. Once detected, the value is transmitted to the interface manager. The interface manager is responsible for transmitting the detected values to the remote players over the communication network. The intelligent table includes the familiar bet board for a variety of different games of chance. The gaming object will vary depending on the selected game of chance. The present invention provides the capability to adapt common casino games, and particularly card games, to remote play by a plurality of remote players.

### BACKGROUND OF THE INVENTION

1.Field of the Invention

The present invention relates to a system and method for remote gaming and more particularly a system and method that enables remote players and local player at a casino to participate in a live action game of chance.

2

Playing games of chance over the Internet is a popular past-time for many people. Indeed a number of “on-line” casinos attract a large number of players who are otherwise unable to travel to a physical casino and play their desired game of chance. In this Internet embodiment, the casino is little more than a computer server connected to the world wide web or other communication network. The computer server acts as a gateway to one or more computers that execute computer software replicating a game of chance. For example, the computer software could replicate the game of roulette, baccarat, craps, blackjack or pai gow (an Asian poker game) depending on what game of chance a player desires to play. Thus, when the user accesses the computer server, their request to play a particular game is directed to one of the computers executing the requested software.

While a software-generated game of chance may closely replicate the odds of winning, many players would prefer to play at an actual casino where there is a real deck of cards or pair of die. For this reason, a real-time interactive gaming system (RIGS) was described in U.S. Pat. No. 5,762,552, assigned to VT TECH Corp., the assignee of the present invention. The RIGS provides a system that permits remote players to participate in live action games of chance. By way of example, a remote player selects a game server, which may be a table located on the floor of a casino. The RIGS transmits broadcast quality signal to the remote player so that they can monitor play at the table. The RIGS is particularly well suited to games of chance such as baccarat, roulette and craps where a virtually unlimited number of players may place electronic bets on a virtual bet board with the outcome determined by the cards opened on the baccarat table, the play of the roulette wheel or the roll of the die on the crap table. Advantageously, the baccarat table, the roulette wheel and the craps table are all located on the casino floor, so the remote player is provided with the same game just as if they were seated at the gaming table in the casino.

For casino card games such as black jack, pai gow, poker, detecting not only the outcome but also the intermediate results is necessary. When cards are dealt face down, it is difficult to determine the value of the cards. Optical recognition may be used by positioning a camera under the table and placing the cards over the camera lens. Once determined, the value of the card is then transmitted by the RIGS to the remote player. Unfortunately, optical recognition is computationally intensive so it could slow down the rate of play. Further, optical recognition requires that the cards be precisely dealt so that the value of the cards may be quickly determined. Perhaps most important though, optical recognition is also expensive because each remote position must be equipped with video recognition hardware. For example, the hand of a remote black jack player must be determined and transmitted to the remote player, unless it can be clearly captured by the live video of the overall backjack table. Accordingly, the prior art detection means are unable to readily determine the value of the cards, especially when they are dealt face down (as is the case of the game of blackjack where the first card is an ace or a ten to determine if a blackjack occurs). Clearly, what is needed is a method to detect the value of the cards in a fast but inexpensive manner. What is also needed is a method for implementing casino card games in a manner that permits an unlimited number of remote players to participate at a casino card game without causing any disruption to other players who are physically present at the table.

For casino games, such as roulette, baccarat and craps, the automatic detection of the outcome is needed to eliminate the need for a casino employee to view the result and manually enter the value into the RIGS for distribution to remote players. Clearly, it would be advantageous to automatically detect the value of the cards after they are turned open on the baccarat table, or of the die after a player throws the die onto the craps table or after the roulette ball is positioned in a final slot on the roulette wheel.

Finally, an improved system and method is necessary to permit an unlimited number of remote players to participate at a live game of chance and especially casino card games without disrupting the game's results or rate of play for players physically present at the same table. This scalability on the number of players is critical for substantially increasing casino revenue.

### SUMMARY OF THE INVENTION

The present invention relates to a system and method for detecting the outcome of a game of chance in a casino. More particularly, the present invention relates to an improved system and method for playing a live game of chance from a plurality of remote locations in an efficient manner.

The system comprises an intelligent table adapted for playing a live game of chance and a table manager for interfacing the table to a computer network and a detectable gaming object. The gaming object provides a unique value that, upon detection, is communicated to the table manager. The table manager is responsible for transmitting detected values to the remote players over the communication network. The intelligent table includes the familiar bet board for a variety of different games of chance and at least one detector adapted to detect the value transmitted by the gaming object.

The gaming object will vary depending on the selected game of chance. For example, if the game of chance is a casino card game, the gaming object is a deck of cards having 54 unique values. If the game of chance requires dice as in the craps game, the gaming object comprises the dice, each has the six unique values corresponding to the six sides of die, and if the game of chance is roulette, the gaming object is the steel or plastic ball whose position on the roulette wheel will determine one of the 38 (or 39) values. Each gaming object is adapted to generate at least one unique signal that may be detected by the intelligent table.

The present invention provides the capability to adapt common casino games, and particularly card games, to live remote play. Advantageously, the present invention permits a large number of remote players to independently play a game of chance in a manner that does not affect either the rate of play or the outcome of the game for the other players physically present at the table.

These and other advantages of the present invention are more clearly described in the following detailed description of a preferred embodiment.

### DESCRIPTION OF THE DRAWINGS

FIG. 1 shows a block diagram of one embodiment of an exemplary computer-based system for practicing the invention.

FIG. 2 illustrates a top view of a gaming table in accordance with the present invention.

FIG. 3 illustrates one embodiment of a table controller associated with the gaming table of FIG. 2 and coupled to a plurality of non-contact readers.

FIG. 4 illustrates a schematic representation of a non-contact reader.

FIG. 5 illustrates one embodiment of a gaming object comprising a plurality of playing cards.

FIG. 6 illustrates another gaming object. Specifically, a casino chip or token 602 is shown having an embedded module 602

FIG. 7 illustrates another embodiment of a gaming object.

FIG. 8 illustrates another embodiment of a gaming object.

FIG. 9 illustrates a portion of a roulette wheel in accordance with the present invention having a plurality of readers.

FIG. 10 illustrates one embodiment of a smart detector aid.

FIG. 11 illustrates another embodiment of the smart detector aid.

FIG. 12 is a flow diagram showing the sequence of play for a card game such as black jack.

FIG. 13 is a flow diagram showing the sequence of play for another card game illustrating the flexibility of the combination of a prior art real-time interactive gaming system (RIGS) with the gaming objects of the present invention.

FIG. 14 is a flow diagram showing the sequence of play for a roulette game so as to further illustrate the flexibility of the combination of the RIGS with the gaming objects of the present invention.

FIG. 15 is a flow diagram showing the sequence of play for a poker game in combination with the RIGS and the gaming objects of the present invention.

FIG. 16 illustrates a user console associated with the gaming table of FIG. 2.

### DETAILED DESCRIPTION OF A PREFERRED EMBODIMENT

The present invention relates to a system for enabling remote play of a live action game of chance. More particularly, the present invention relates to an improved gaming table and a plurality of gaming objects and a method that enables an unlimited number of players to participate in a live action game of chance. In the following description of the preferred embodiment, reference is made to the accompanying drawings that form a part hereof, and in which is shown by way of illustration a specific embodiment in which the invention may be practiced. It is to be understood that other embodiments may be utilized and that changes may be made without departing from the scope of the present invention.

Reference will now be made in detail to the preferred embodiments of the invention, examples of which are illustrated in the accompanying drawings. Wherever possible, the same reference numbers will be used throughout in the drawings to refer to the same or like components.

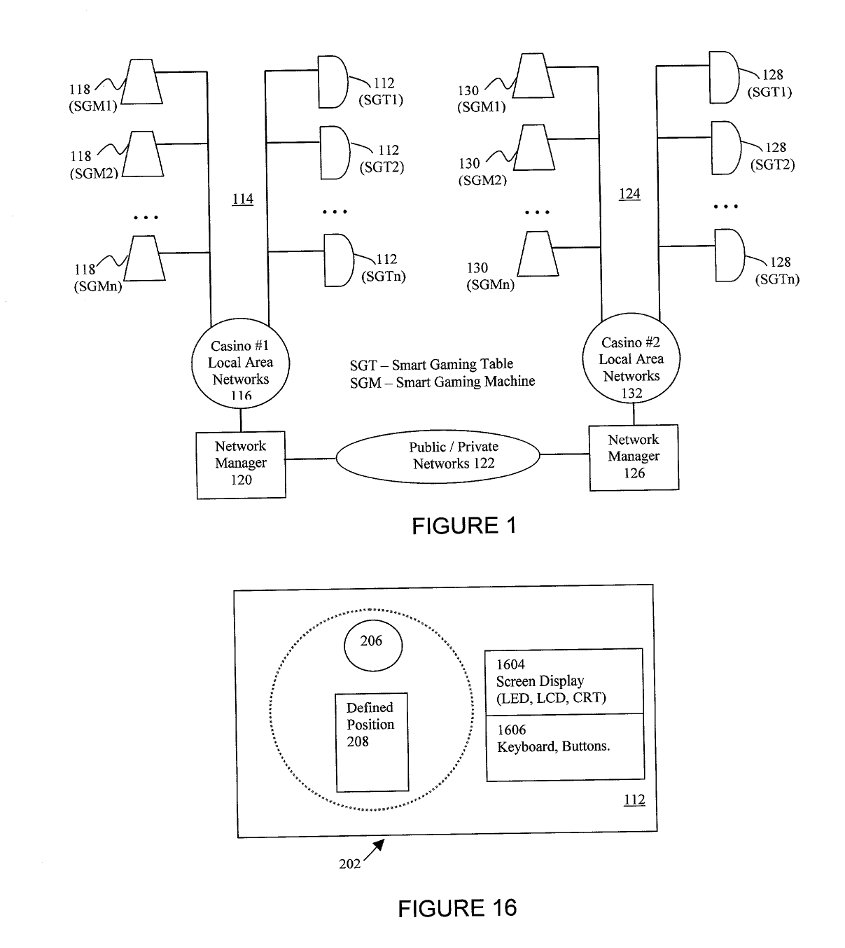

FIG. 1 illustrates the hardware components of an exemplary computer-based system 110 for practicing the invention. Specifically, the present invention comprises a plurality of smart gaming tables 112 at a first casino 114. At each table, a sequence of plays of a particular game of chance is conducted. Each table 112 is connected to a local area network 116. A plurality of gaming machines 118 is also connected to network 116. By selecting one of said plurality of tables 112, a remote player (not shown) positioned at one of the gaming machines 118 can participate in the play of the game of chance conducted at the selected table.

Casino 114 also includes a network manager 120, which is connected to network 116. Network manager acts as a portal to a public or private network 122, which may be a telephone, satellite or Internet network or any other world wide communication network. Also coupled to network 122 is a second casino 124 via network manager 126. Casino is essentially a mirror image of casino 114 in that it comprises a plurality of gaming tables 128 and gaming machines 130 each and which are coupled by a local area network 132 to network manager 126. Gaming machines 130 are identical to gaming machines 118 except that they is located at a site remote from casino 114. Similarly, gaming tables 128 are identical to gaming tables 112 except that they too are located at a different site.

One advantage of the configuration illustrated in FIG. 1 is that a player at one of the gaming machines 118 can play a game of chance being conducted in a different casino at one of the gaming tables 128. Thus, a player at a casino situated in a part of the country could play the tables at an associated casino in another part of the country. This configuration is disclosed in U.S. Pat. No. 5,762,552 which issued Jun. 9, 1998, assigned to VT TECH Corp. the assignee of the present invention, the disclosure of which is incorporated herein for all purposes. However, in accordance with the present invention, the computer-based system 110 is improved by including improved “smart” gaming tables that enhance the speed and reliability of play of a wide range of games of chance.

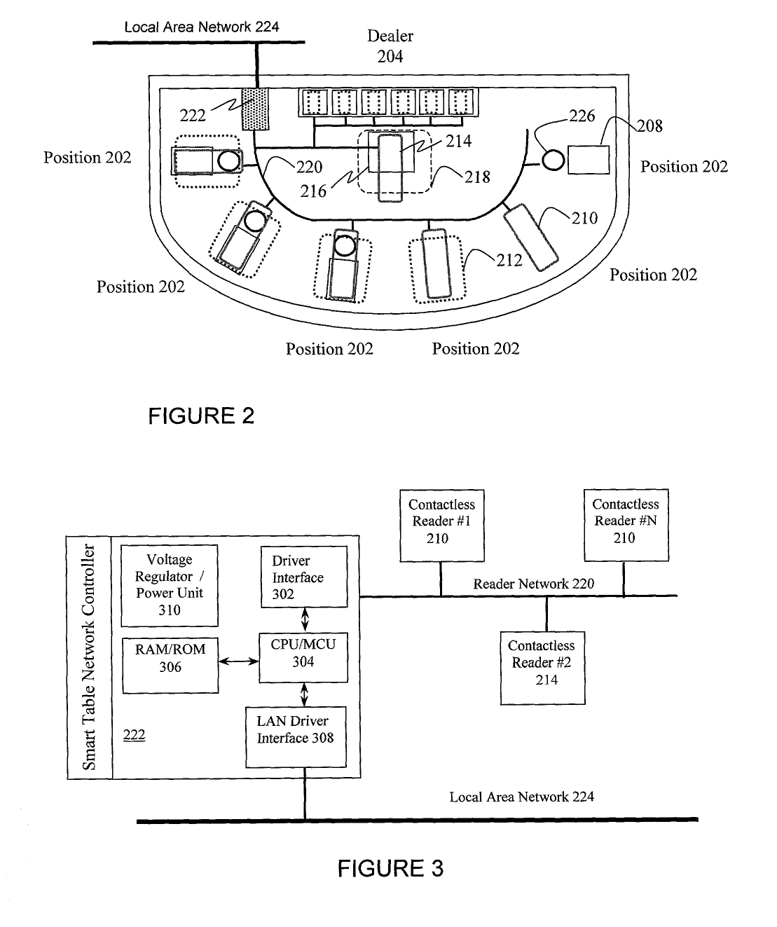

Referring now to FIG. 2, a top view of a gaming table 112 is illustrated. Table 112 comprises a flat playing surface covered with felt on which is typically printed a bet board for a particular game. The printed felt could delineate where the cards are dealt and where the bets are positioned. Typically there are a total of six playing positions 202 if the table is used for blackjack or pai gow poker and a dealer position 204. Other card games may have more or fewer playing positions or may omit the dealer's position. Associated with each playing position 202 is a bet slot 206 where a player may place a bet for the next to occur game of chance. Also associated is a defined position 208 where the cards are dealt.

At each playing position 202, a reader 210 is coupled to table 112 and closely proximate to at least one of the playing positions 202. In the illustrated embodiment, each playing position 202 is provided with a reader 210 although it has been eliminated from one position in FIG. 2 so as to more clearly illustrate additional features of each position 202. One skilled in the art will appreciate that each table may have any number of positions 202 and is not limited to merely the six positions 202 that are illustrated. Each reader 210 is configured to have a relatively short range as indicated by the dashed lines 212 surrounding each player position 202. Again, the range indicator has been omitted from two positions so as to more clearly illustrates the reader and other features at these positions.

Table 112 also includes a reader 214 positioned proximate to the dealer position 204 and more particularly proximate to the defined position 216 where the dealer's cards are initially positioned. As with readers 210, readers 214 are configured with a relatively short range, as indicated by dashed lines 218 so that there is no overlap in detection field with the other readers. Each table 112 includes a reader network 220 that terminates at a table manager 222. Table manager 222 is responsible for coupling reader network 220 to a local area network (LAN) 224. Table manager 222 is the local manager responsible for linking and managing access to the network manager 120 (FIG. 1) via LAN 224.

Table 112 further comprises in one embodiment a chip tray proximate to the dealer's position 204. The chip tray is coupled to reader network 220 such that the total number of chips in the tray may be counted and the value transmitted to a monitoring server coupled to LAN 224.

As shown in FIG. 3, table manager 222 comprises a reader driver interface 302 that manages the local reader network 220. Interface 302 is responsible for acquiring the value of each card (or RFID chip) positioned within the detection range of each reader 210 and 214. Once acquired, the information is interpreted by CPU 304 using the control instructions that are stored in memory 306. Memory 306 also serves as a local store for the information acquired by each reader 210 and 214. Memory 306 may comprise a combination of both volatile (RAM) for data storage and non-volatile memory (ROM or Flash) for program storage. A LAN driver interface 308 operates under control of CPU 304 and couples table manager 222 to LAN 224. As will be appreciated, since a plurality of tables 112 are coupled by LAN 224 to network manager 120, each controller 222 is responsible for indicating to network manager 120 intermediate results and completion of each game of chance. Table manager 222 further comprises a power supply dedicated to the operation of network controller.

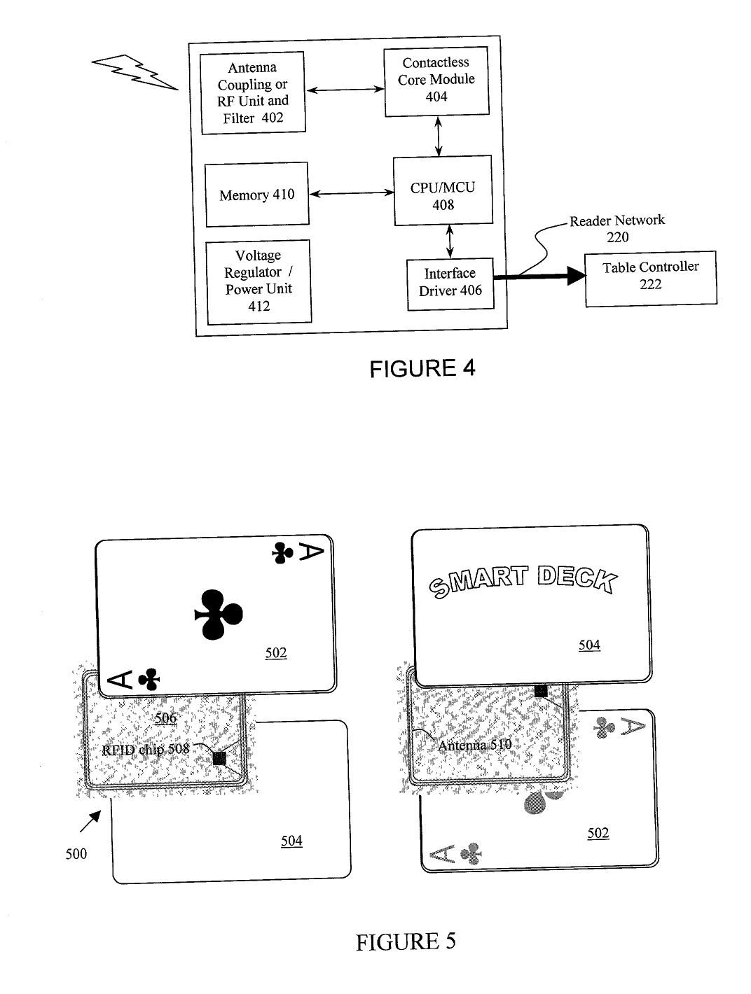

Referring now to FIG. 4, a schematic representation of non-contact readers 210 and 214 is shown. For purposes of illustration, reader 210 will be discussed but it is to be understood that reader 214 will be identical thereto. Reader 210 comprises an antenna 402 that detects the proximity of a Tag-It™ I•CODE™ chip module having a transponder. Commercially available non-contact technology such as Mifare™, HITAG™, I•CODE™ which is available from Philips, TIRIS™ and Tag-It™, which is available from Texas Instruments, or COIL-ON-THE-CHIP™, which is available from Maxwell. The primary requirement being that the non-contact technology support an anti-collision algorithm to enable the detection of each card in a stack of playing card or detection of each chip in a stack of chips. Alternatively, antenna 402 may comprise a radio frequency detector for detecting an RF signal. Antenna 402 includes a filter that filters any detected RF signal. It will be understood that the length of the antenna will determine the range of reader 210. More specifically, the range of the reader 210 is preferably a circle (or other selected geometric area) having a radius of about three inches. However, it should be apparent that the actual range will be determined by the application and may be either larger or smaller depending on the application. Typically, the reading range of the reader will be determined by the number of turns and/or size of the antenna and is variable according to a specific application.

Since the output of the antenna filter combination 402 is analog, it is also converted to a digital signal before it is passed on to core module 404. Core module 404 comprises a semiconductor chip, such as_Tag-It™, I•CODE™, commercially available from Texas Instruments and Phillips Semiconductor respectively. Similar chips are available from other manufacturers such as Motorola. Core module 404 is responsible for determining the data exchanged between a reader and gaming objects.

The output of core module 404 is transferred to interface driver 406. Driver 406 converts the output of core module 404 from a TTL logic level to the appropriate logic level for reader network 220. For example, driver 406 converts the output to RS-232, RS-485, Ethernet, token ring or other such bus protocol.

A microprocessor 408 is responsible for managing the operation of reader 210 and the transfer of information from module 404 to driver 406. Specifically, microprocessor 408 executes an application program that is stored in a non-volatile portion of memory 410. Real-time data storage is provided by the volatile portion of memory 410. A power supply 412 is also provided in each reader 210 although it will be appreciated that supply 412 could be omitted and power supplied by the power supply associated with table manager 222. The power supply is responsible for regulating the various voltage levels required to operate the reader.

Referring now to FIGS. 5-8, various embodiments of the gaming object are illustrated. A gaming object is a device that enables the game of chance to be played at a table and readily detected for transmission to the remote player. Each gaming object is encoded with a certain information that assists the readers in determining either the value of the gaming object or, alternatively, the orientation of the gaming object. One example of the encoded information is shown in Table 1.

The field names in Table 1 are described as follows:

UMID means the Unique Manufactured ID. It is a Read Only field and is generated by the semiconductor manufacturer. UMID is a unique alphanumeric sequence is dedicated to a specific casino company or owner. By way of example, the sequence 0×11223344556677 could designates a casino owned by a fictional company in Las Vegas while the sequence 0×11223344550000 could designate the company's Atlantic City casino property.

WAC means Write Access Condition. It is a Read/Write field that reflects which portion of memory is protected (preventing overwritten). Casino owners utilize this field to protect certain fields from being selectively overwritten. Once a field is protected (write once) then it can not be unprotected and rewritten.

SFC means Special Function Code. It is a Read/Write field that accommodates specific reader/encoder operations such as Encryption Scheme ID to reader/verifier.

TABLE 1

| Field | Field | Access | |
|---|---|---|---|
| No. | Name | Status | Description |
| 1 | UMID | RO | Unique manufacturer ID dedicated to casino |
| | | | encoded name |
| 2 | WAC | R/W* | Write Access Conditions |
| 3 | SFC | R/W | Special Functions |
| 4 | CAIN | R/W | Casino Application Identifier Number |
| 5 | CAVN | R/W | Casino Application Value Number |
| 6 | CASN | R/W | Casino Application Serial Number (Unique) |
| 7 | CCI | R/W | Casino Control Information |
| 8 | CSI | R/W | Casino Status Information |
| 9 | CRA | R/W | Casino Reserved Area |
| 10 | VISN | R/W | Vendor Issued Serial Number |
| 11 | VSI | R/W | Vendor Status Information |
| — | | | Reserved Area |
| N-3 | | R/W | Memory Size |
| N-2 | | R/W | Parity Check |
| N-1 | LRC | R/W | Longitude Redundancy Check |
| N | CSV | R/W | Checksum Value |

CAIN means Casino Application Identifier Number. It is a Read/Write field that characterizes the gaming object. Specifically this field specifies whether the gaming object is a playing card, a chip or token, dice, roulette ball, or other gaming object. For example, if the CAIN field is: 1=chips, 2=playing cards, 3=dice, 4=ball. The CAIN field may also indicate the characteristics such as color, sizes, shapes, etc.

CAVN means the Casino Application Value Number. It is a Read/Write field that indicates the unit amount associated to CAIN field. By way of example, if the CAIN field is a “2” thereby indicated that the gaming object is one of a set of playing cards, then the CAVN field will have a valid range between 1 to 54 to indicate the suit and the value of each card. In one embodiment, a CAVN value of 1 denotes an Ace of Heart, a value of 13 denotes a King of Heart, a value of 14 denotes an Ace of Diamond, a value of 26 denotes a King of Diamond, a value of 27 denotes an Ace of Club, a value of 39 denotes a King of Club, a value of 40 denotes an Aces of Space, a value of 52 denotes a King of Space, a value of 53 denotes a first Joker, and a value of 54 denotes a second Joker. Chips (Coins or Tokens) will have a number that represents an exact unit amount of the chip value. For example, the number will represent a multiple of a minimum unit value, for example a CAVN of 2500 denotes a chip value of $25.

CASN means the Casino Application Serial Number. It is a Read/Write field dedicated to casino operations tracking number. It is a unique key relating to casino operation.

CCI means the Casino Control Information. It is a Read/Write field that indicates expiration period/date, training only (not be able for cash redeem or valid on any gaming tables), valid region code (e.g. only valid in North America). This field will indicate the validity or scope of usage.

CSI means the Casino Status Information number. It is a Read/Write field that represents the issue date and lot number.

CRA means the Casino Reserved Area. This area is a Read/Write field available for future enhancements or special data the casino desires to encode into the gaming object.

VISN means the Vendor Issued Serial Number. It is a Write Once field that is a unique serial number generated by a third party supplier (beside the chip module manufacturer) for each gaming object.

VSI means the Vendor Status Information. It is a Write Once field that represents the issue date and lot number of a third party supplier.

In addition to these illustrative fields, the gaming object may include enhanced features such as a mutual authentication data, data encryption keys or configurable public or secret memory.

If the game of chance is a card game, the gaming object is a deck of cards such as illustrated in FIG. 5. Each card in a deck has a first and second layer 502 and 504, respectively. Layers may be a heavy grade of paper, a thin plastic sheet or other material commonly used to manufacture cards. Alternatively, the cards may be formed from a paper slurry in which case there is a single structure having a top surface corresponding to layer 502 and a second surface corresponding to layer 504.

Each layer 502 and 504 may be printed on one side and bonded to the other layer on the opposing side. For example, as illustrated, layer 502 has an outer surface that is printed with a card value such as the Ace of Clubs while layer 504 has a printed outer surface with a casino logo or a decorative design. One familiar with a deck of playing cards will recognize that layer 502 equates to the “face” of the card while layer 504 equates to the top of the card which is visible to a player when the cards are dealt “face down.” The inner surface of layers 502 and 504 may be blank or printed with security information such as an identification number.

Sandwiched between layers 502 and 504 is a RFID module 506 or other type of contact-less integrated circuit. Module 506 comprises a semiconductor chip module 508 coupled to a coiled or circular antenna 510. Antenna 510 may be either a coil of wire adhesively affixed to the surface of module 506 or printed thereon using a conductive ink. If the cards are formed from a paper slurry, module 506 is positioned in the approximate middle of the structure and effectively embedded therein as the slurry cures in to a single card-like structure.

Module 506 is powered by the non-contact RF field generated by readers 210 or reader 214. Advantageously, no battery or other source of power need be associated with the gaming objects because the module 508 generates its own power whenever it is in the presence of a tuned RF field. Advantageously, each gaming object includes a unique identification code and a programmable non-volatile memory section to further aid the casino in monitoring the play at table 112 and generating reports regarding the playing statistics. Module 506 includes a feature that enables the casino to program the contents of the memory and then to lock or protect the entire memory or a portion of the memory from further re-writes or alteration.

By bonding the inner surface of layers 502 and 504, module 506 is permanently positioned there-between. In an alternative embodiment, module 506 may be omitted and chip 508 and antenna 510 may be directly attached to one of the substrates 502 and 504. Thus, when the gaming object, which in this example is a card, is positioned proximate to readers it is able to determine the value of the card using proximity detection techniques. By employing an anti-collision algorithm in microprocessor 408 it is possible to determine how many tokens are positioned in bet slot 206 and the value of any gaming objects in proximity of the corresponding defined position 208. For example, when selected with the anti-collision/select command, each I•CODE™ chip responds with its own unique 64 bits serial number in different timeslots, the timeslots are controlled by the controller.

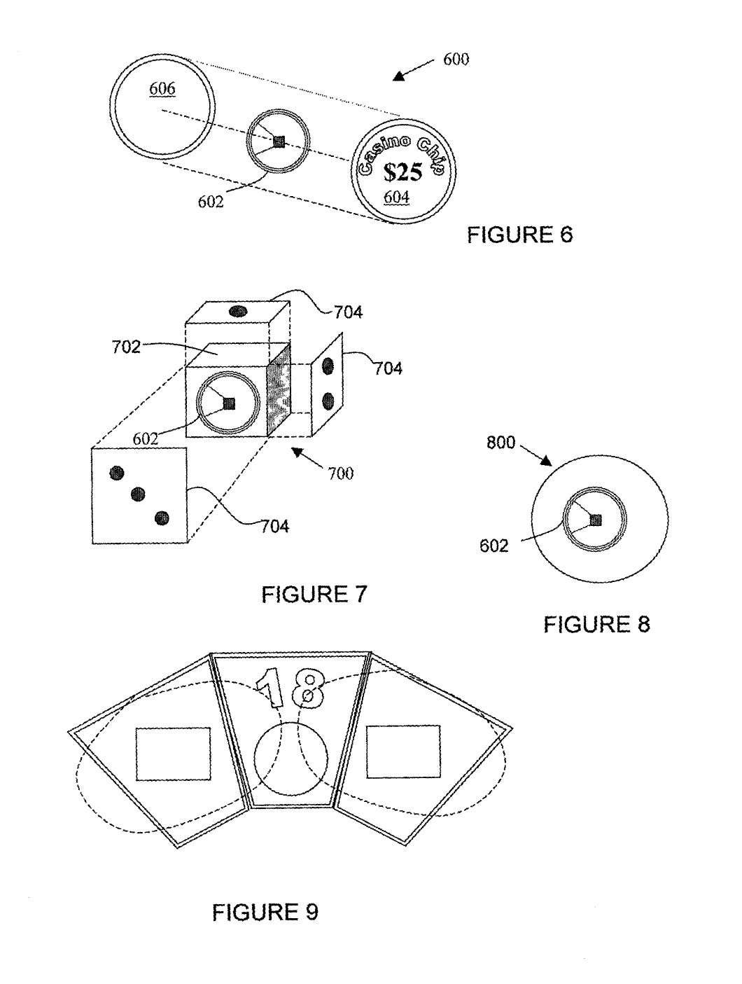

FIG. 6 illustrates another gaming object. Specifically, a casino chip or token 600 is shown having an embedded module 602. In one embodiment, each token 600 includes a pair of substrates 604 and 606 that are bonded together sandwiching module 602. As with the deck of card embodiment illustrated in FIG. 5, module 602 may be omitted if the chip and antenna are directly printed on one of the substrates 604 and 606. For token 600, a value may be programmed into the memory of the chip for detection by reader 210 or 214.

FIG. 7 illustrates yet another gaming object. Specifically, a dice 700 is shown. As will be understood, each dice has six sides each with a unique value. When a dice is thrown, it is necessary to determine which side is positioned in the “up” position. Accordingly, the gaming object provides that each face of the die has an associated module 602 (only one face is illustrated). In one preferred embodiment, the dice includes an inner cube 702. Each face of the cube has a module attached thereto. Then outer faces 704 (only three of which are shown) are formed over the inner cube so that each of the six modules 508 are sandwiched between corresponding faces of the inner and outer cubes. To enable reliable detection, antenna is adapted to minimize the detection range of the dice to a distance of no more than half the height of each face. By detecting the bottom face of the die, it is possible to determine the corresponding face that is facing upward.

FIG. 8 illustrates yet another gaming object. This sectional view illustrates a roulette ball that is readily detected when it resides in a slot of a roulette wheel. In one preferred embodiment, the ball 800 is ceramic and module 602 is embedded therein. The size of the antenna associated with module 602 in the ball is sufficient so that a programmed serial number may only be detected from a distance of less than the width of one and a half slots on a roulette wheel.

As shown in FIG. 9, a plurality of readers 210 are positioned in alignment with at least every other slot on the wheel. Each reader will have a detection range as indicated by dashed lines 902. Thus, when a ball 800 is positioned in a slot having a reader (not shown), the associated reader will detect the ball. When the ball is positioned in a slot between the two slots having the readers, both of the adjacent readers will detect the presence of the ball 800. By extrapolating the reading from the two readers, table manager 222 determines the slot where the ball is residing. Each reader is coupled to the reader network 220 by a short range RF transmitter coupled to the bottom side of the rotating roulette wheel.

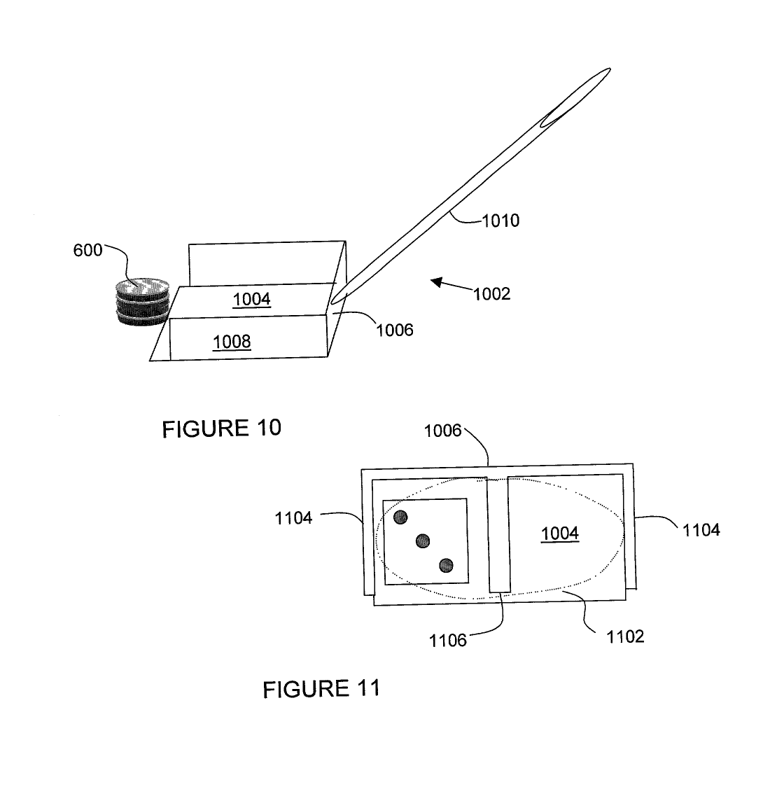

Referring now to FIGS. 10 and 11, a smart detector aid 1002 is illustrated. FIG. 10 is a perspective side view of aid 1002. The embodiment of FIG. 10 is particularly useful for collecting a stack of chips from a craps table or a roulette board. The collection tray 1004 includes a reader adapted to calculate the value of a stack of chips or tokens 600. The smart detector aid 1002 may include optional rear and side portions 1006 and 1008, respectively, so as to secure the stack of tokens onto tray 1004. A handle 1010 may be used to extend the reach of aid 1002.

The embodiment shown in FIG. 11 is a top view of a portion of another embodiment of the aid. This embodiment is particularly well suited for collecting and automatically determining the orientation of a pair of die. In this embodiment, a reader having a detection range indicated by dashed lines 1102 is formed in tray 1004. An additional pair of readers may be attached to opposing side portions 1104 so as to enable the detection of outward facing faces of a die. As illustrated in FIG. 11, tray 1004 is divided into two wells formed by a dividing wall 1106. Although not illustrated, a handle may be further attached to the back portion 1006.

In a typical application, the reading range of each reader will vary from application to application. By way of example, reading ranges between 0.5 mm to 5.0 mm will provide sufficient coverage. The primary goal is to enable the reading of a transponder in a defined area while preventing the reading of a transponder outside of the defined area, such as at an adjacent playing position. Clearly, there should be no overlap of reading ranges between adjacent playing positions. The reading range is determined by the size of the antennas of the transponder and the reader and may be adjusted as dictated by the engineering requirements of each game of chance.

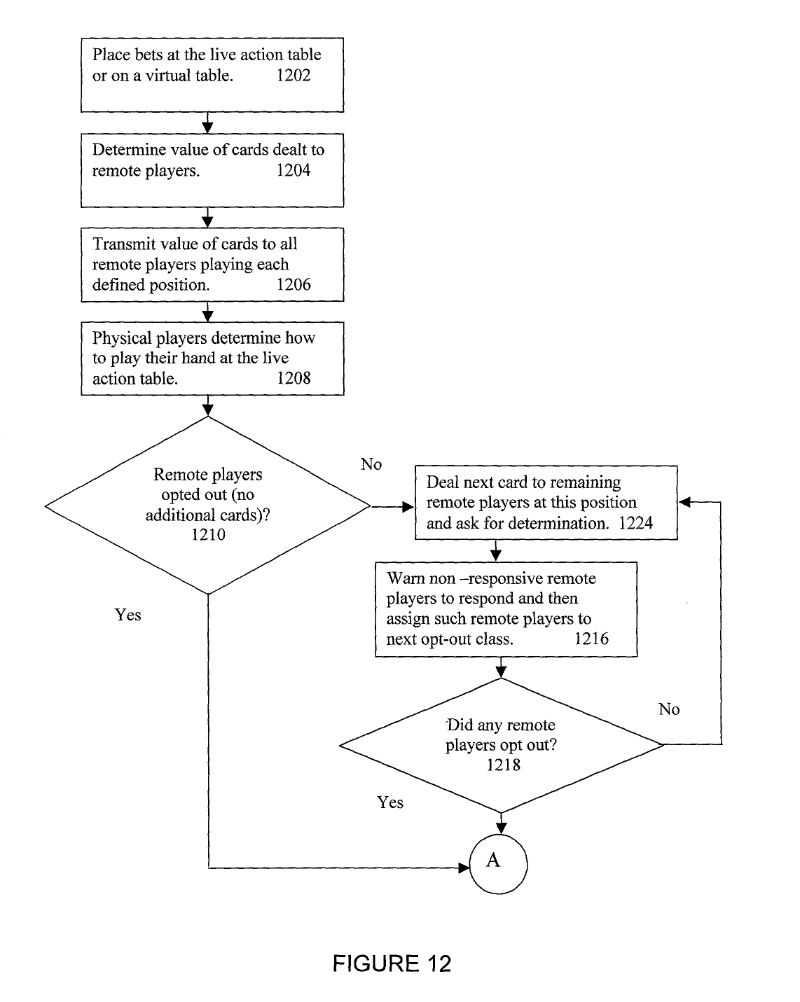

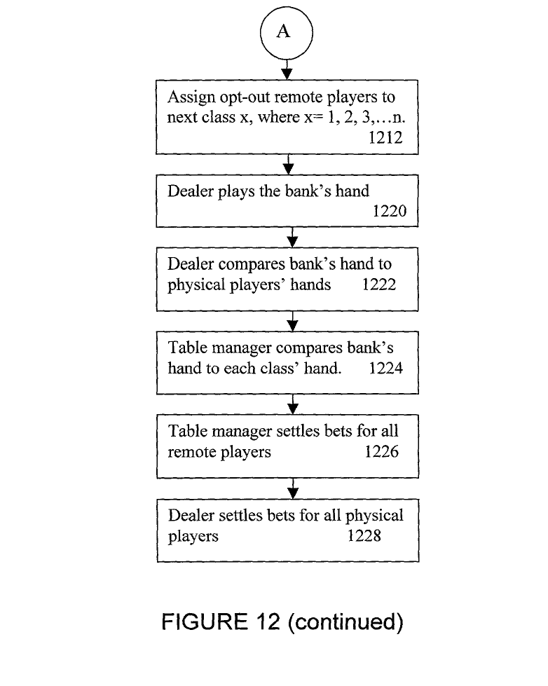

Referring now to FIGS. 12-15, the order of play for exemplary casino table games are described. By combining the above described system components with the following description of play sequence, it will be appreciated that a plurality of remote players may participate in the game together with players who are physically present at the table (physical players). Advantageously, the remote players may make their individual decisions on how to play the game without impacting the decisions of other remote players.

As shown in FIG. 12, the sequence of play for a card game such as black jack begins with the players placing their bet as indicated at step 1202. If the player is a remote player, the bet is place by accessing a line of credit. The remote player may place a bet at any time and it will be accepted for the next to occur play of the game. If the player is a physical player the bet is place by positioning a stack of chips at the appropriate spot at each player position 202 on the table 112. Readers associated with each position 202 detect the value of the stack of chips.

When bets are placed, the dealer deals the game object, which in this game are the active cards 500, and each player is provided two initial cards. At any position where remote players are playing, all of the remote players are dealt the same two cards. Readers 208 determine the value of the cards as indicated at 1204 and transmits this information to each remote player via LAN 116 (if the remote players are in the casino) or via network manager 120 and network 122 (if the remote player is remote from the casino) as indicated at 1206.

The dealer then sequentially asks each player (whether physical or remote) whether they want additional cards. If the player is a physical player, the player may either view the current value of the cards at a display or calculate the value of their card on their own as indicated at step 1208.

If, however, the player is remote (recall that there can be any number, such as one or thousands, of remote players playing at this position), the dealer may be requested to deal a series of cards. Accordingly, remote players must either “opt-in” or “opt-out” of the remaining sequence of cards as indicated at step 1210. If the remote player opts-out (that is, stands with the current cards), a first class (that is class 1) is defined consisting of all such remote players as indicated at 1212. After the next subsequent card is dealt, the remaining remote players must again determine how they wish to proceed as indicated at step 1214. If one or more remote players are non-responsive, the dealer may advise that the remote players must decide to opt-in or opt-out or else they will be automatically opted-out as indicated at step 1216. Those remote players who opt-out (including the non-responsive players) are then assigned to the next class (i.e., class 2) at step 1218. If at least one remote player opts in, the process continues with flow returning back to step 1214 until all remote players are assigned to a class, with the last class, class n, most likely being the group of remote players that drew too many cards and went busted (automatic opt-out).

Table manager 222 is responsible for transmitting the value of the initial cards and each subsequent card dealt to the remote player position. It is also responsible for transmitting to the dealer the desire of at least one remote player to draw another card.

If a remote player is slow or non-responsive such that the remote player does not opt either in or out in a timely manner, table manager 222 is responsible for communicating to the non-responsive remote players that they have been automatically assigned to the previous class as indicated at step 1216. Once all remote players are assigned to a class, the dealer proceeds to other players until all players have played out their hand.

The dealer is then tasked with playing his or her hand in accordance with the rules of play established by the casino as indicated at step 1220. The dealer then compares the results of the dealer's hand with each player's hand (step 1222). Since the dealer's hand is detected by reader 214, which is coupled by the reader network to table manager, it is possible for table manager 222 to automatically compare the dealer's hand with the hand for each class of the remote players as indicated at step 1224. While the dealer is settling the bets for the physical players, as indicated at step 1226, the established credit line for each remote player is updated to indicate whether the remote player either won or lost as indicated at step 1228. Advantageously, the present invention permits the casino to monitor in real-time the payout of bets and to make sure that the dealer is correctly handling the bets placed by physical players because the chips bet by each physical player are counted by each reader 210 associated with a defined position.

It will be appreciated that the present sequence of play permits a large number of remote players to play a single hand. While the likelihood that some remote players will draw sufficient cards until they go broke, this is no different than if a single player were to draw the same number of cards. By way of example, assume that class 1 remote players stand with the initial cards as dealt by the dealer and that the initial value of the cards equals a value of 11. Assume also that class 2 remote players draw a card and receive a card having a value of 7 so that the total value for class 2 players is 18. Assume that class 3 remote players draw yet another card, hoping for an ace, a two or a three but instead receive a card having a value of 10. Accordingly class 3 remote players are busted and their bets are collected by the casino. When the dealer completes his or her hand, (assume a value of 17) it is compared to the value of class 1 remote players. Given the respective values, it is determined that class 1 players have lost their bets. In contrast, class 2 players are found to be winners and their bets will be paid by the casino. The determination, collection and pay-off is automatic for remote players thereby relieving the casino employees from settling these bets.

Also, there is the possibility that some players (that is, class 4) may wish to “double down” and receive a single card (hoping for a card with a value of 10). This single card will be the previously described card having a value of 7 so their total value is 18. Accordingly class 4 remote players are also winners although they will have played a different wager amount than the other three classes. Accordingly, this class of remote players will be paid an amount different from the amount paid to class 2.

A similar scenario will occur if the dealt cards were a pair of 10's or a pair of aces and some remote players wanted to split the cards and play two independent hands. Other classes of remote players will not split and they will be dealt either one (class 2), two (class 3) or three (class 4 ) cards. The system of the present invention permits these different strategies to proceed in parallel, the only requirement is to detect the card and to configure the cards so that it provides the proper result for each class of remote players. Advantageously, since the RIGS system provides for video feeds, each player, both physical and remote, can observe when the network controller is informing the dealer that additional cards are requested by at least one remote player.

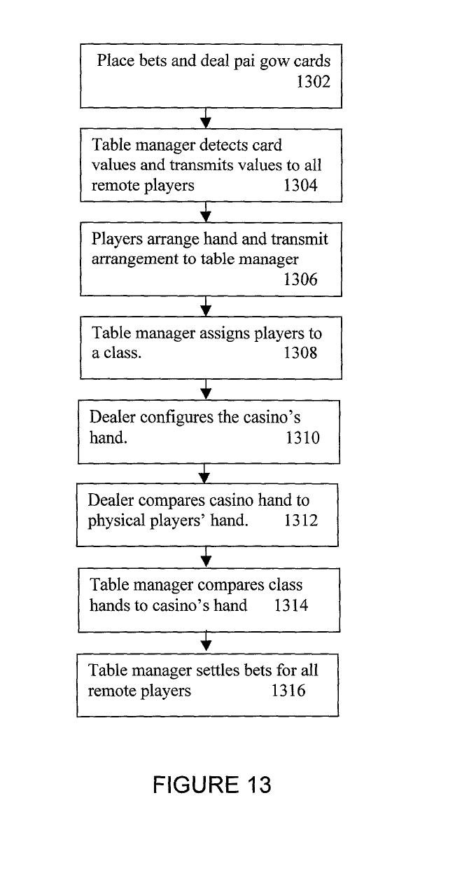

Referring now to FIG. 13, a method is described for another card game, specifically pai gow poker, so as to illustrate the flexibility of the combination of the RIGS with the gaming objects of the present invention. The method begins with bets being placed and the dealing of seven cards to each position at a pai gow poker table as indicated at step 1302. Readers 210 detects the value for each of the seven cards and reports the seven values to each remote player as indicated at step 1304. In a preferred embodiment, the card values are shown as a generated video image because the cards will of course be dealt “face down”. Each player (both remote and physical) is then provided a period of time in which they independently arrange their cards in accordance with the rules of pai gow poker. The arrangement is transmitted back to the table manager 222 as indicated at step 1306. Each remote player is assigned to a class by table manager 222 depending on how they arranged the cards as indicated at step 1308. When all players are ready, the dealer begins to arrange the dealer's card as indicated at step 1310.

Advantageously by the time the remote players have entered in their card arrangement, reader 214 has detected the values of the cards (as indicated at step 1306) and can forecast how the dealer should arrange the cards. If the dealer consistently fails to correctly set up the cards, the casino can take immediate corrective action. Further, if a remote player is excessively slow, the dealer can verbally announce to the remote players that they will have a default arrangement if they do not timely enter in their arrangement. Thereafter the dealer may then proceed with configuring his or her hand. As indicated at step 1312, the dealer then proceeds to compare the dealer's hand with the physical players' hands. Simultaneously, at step 1314, the table manager 222 determines which of the remote players are winners and which are losers. Finally, at step 1316, the bets are either collected or paid off and the method again proceeds to the next game.

It should be apparent that a virtually unlimited number of players may play the same set of cards at a single multiple player position because the present invention permits the casino to aggregate players into classes and treat each class as a single betting entity. Specifically, each player may individually configure their cards at the remote gaming machine 118. As each remote player responds with their card configuration, they are categorized as a member of one, two, . . . or n classes with each class based on a unique remote player selected configuration. Advantageously, the casino is able to increase the size of the average bet played for each remote hand. Table manager 222 is responsible for collecting and assigning remote players to a class, for comparing each class to the dealer's configuration and for either paying or collecting the remote players' bets.

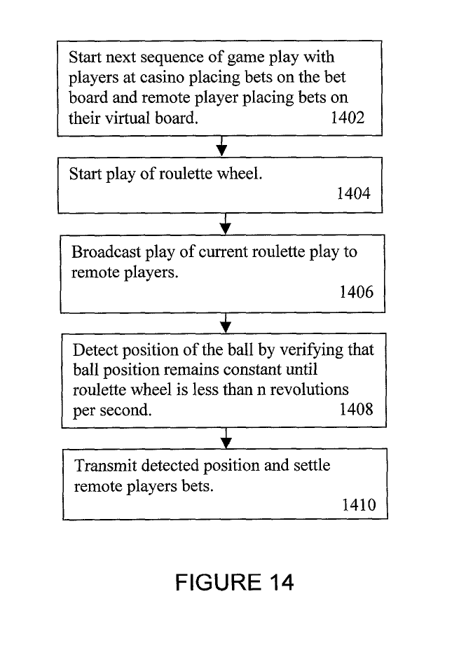

Referring now to FIG. 14, a method is described with respect to a roulette game so as to further illustrate the flexibility of the combination of the RIGS with the gaming objects of the present invention. As indicated at step 1402, at the start of a game sequence, physical players will place their bets on the physical bet board proximate to the wheel. Simultaneously, remote players may enter their bets from their respective gaming machine on a virtual bet board. These bets are transferred to the table manager 222 prior to the start of the play of the game. Then, at step 1404, the roulette wheel is activated and observed by both physical players and remote players, the latter being via the video broadcast signal until a number is selected. The location of the ball is detected at step 1408 and transmitted to the remote players'gaming machine and visually confirmed. Because each of the readers associated with the roulette wheel are coupled to table manager 222 by radio signal, it is possible to detect the presence of the ball before it has settled into a final slot. Accordingly, it is desirable to ensure that the rate of rotation is sufficiently slow to prevent the ball from bouncing to another slot. Based on the detected results, at step 1410, the casino employee will either pay or collect the physical bets while table manager 222 either pays or collects the bets placed by remote players. Again, it should be apparent that a virtually unlimited number of players may play at a single roulette table.

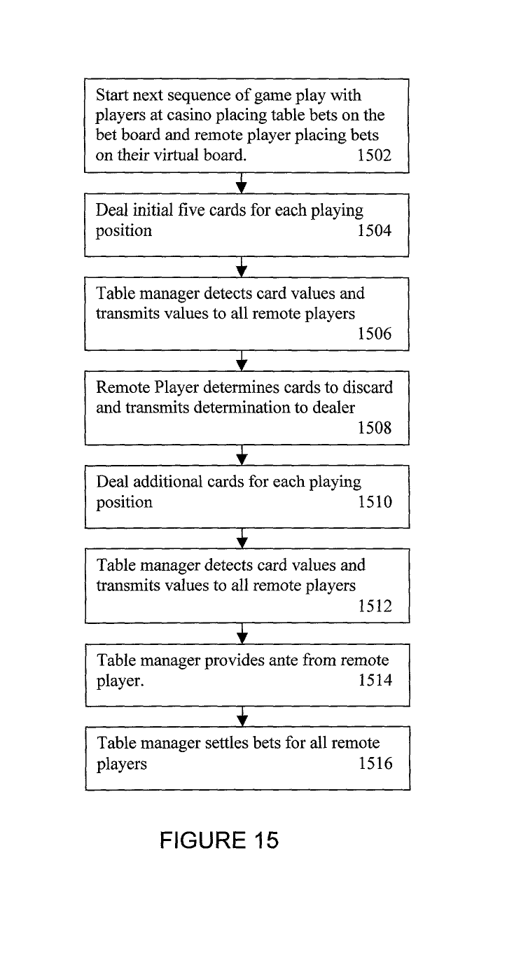

Referring now to FIG. 15, a method is described with respect to a poker game using the combination of the RIGS with the gaming objects of the present invention. In this method, table 112 includes at least one playing position 202 where an initial five cards are dealt to individual slots (not shown) as indicated at step 1502. It will be appreciated that each position 202 may require more than one reader 210 to detect the value of each card because of the physical dimensions associated with the individual slots. Also, associated with each playing slot at the playing position is an indicator (such as an LED light) to indicate which card the remote player wishes to discard. Accordingly, after the initial bets are placed as indicated at step 1502, the dealer deals the initial five cards to each playing position, as indicated at step 1504. Table manager collects the information from the readers and transmits the cards value to the remote player as indicated at step 1506. In step 1508, the remote player indicates the cards, if any, to discard. If any cards are discarded, new cards, in step 1510, are dealt to another single card slot associated with position 202. Alternatively, the dealer collects discarded cards from one, two or three slots and then deals replacement cards to those same slots. Table manager is tasked with determining the final value for the remote player as indicated at step 1512. Thereafter, as indicated at step 1514, the players (both physical and remote) may ante up the bets until a winner is declared with the table manager responsible for transmitting the remote player's bets. Table manager is also responsible for settling the bet after conclusion of the game as indicated at step 1516. By combining the RIGS network of remote gaming machine and smart gaming tables with active gaming devices, it is possible to readily integrate a remote player into a poker game being played in real time at a casino. Due to the nature of poker, playing position 202 is not suited to enabling more than one remote player to play the hand. Accordingly, to bring more remote players into the game, additional playing positions 202 must be provided at table 112.

While various embodiments are discussed showing the use of smart tables and gaming objects, it is to be understood that the smart table may be useful to a physical player who is not comfortable with playing a live action card game, roulette or craps. Accordingly, as shown in FIG. 16 and as an aid to such players who are physically present at the gaming table 112, each playing position 202 includes not only a bet slot 206, defined position 208 for the cards and at least one reader having a reading range indicated by dashed lines 1602 but also a user console 1604. In this manner, even though physically present at the gaming table, the player may be treated by the casino as a “remote” player with the player's hand and bets determined automatically by the casino. Advantageously, a smart playing position, such as position 202, may be used to train players how to play a game, to increase the rate of play by suggesting possible strategies or to implement casino management functions.

User console 1604 may be an LCD display having a touch sensitive screen for entry of information by the physical player. Alternatively user console 1602 may be an array of LEDs or a CRT together with an optional keyboard 1606. User console 1604 receives the value of the cards positioned in defined position 208 as well as the value of the bet positioned in bet slot 206 from table manager 222. Thus, a physical player may obtain visual confirmation of the value of their cards and their bet, if desired. The dealer may also receive determinations or instructions from the remote players on user console associated with the dealer's position. Since it is possible that a large number of players are grouped on more than one class, a visual means of conveying the remote players instructions is preferred to an audible broadcast.

The present invention provides significant benefits for operators of a casino. Specifically, automatically determining the value of a stack of chips, tokens or playing card enables the automatic counting of all bets played at a gaming table with instantaneous monitoring of the play at the gaming table via a computer network. Advantageously, the present invention also enables true automatic broadcasting of a game of chance and the outcome for each player and the dealer via the RIGS.

Further, the present invention contributes to the prevention of the counterfeit cards or chips and minimizes mistakes in calculating the value of the outcome of a game of chance or the proper payoff of a wager. Because the gaming object includes a memory area in the embedded semiconductor circuit, it can be reprogrammed and encrypted by the casino. Finally, use of the gaming objects enable an automated audit trail for both dealer and players at the gaming table so that game results, historical wins and losses, and as a training system. A particularly useful means for printing and encoding gaming objects is the PROXWRITER™ printer and encoder platform commercially available from VT TECH Corp. the assignee of the present invention.

Using user console 1604, a player may automatically log into a player's position to begin play of a game of chance. Advantageously, the player may place a player's identification card over the reader to establish their stake or credit line. The player uses keyboard 1606 to enter private codes or passwords. Alternatively, the player places a credit card over the reader to establish a stake. Player ID cards may be printed and encoded by the casino using the above-mentioned PROXWRITER printer and encoder platform.

While certain exemplary preferred embodiments have been described and shown in the accompanying drawings, it is to be understood that such embodiments are merely illustrative of and not restrictive on the broad invention. Further, it is to be understood that this invention shall not be limited to the specific construction and arrangements shown and described since various modifications or changes may occur to those of ordinary skill in the art without departing from the spirit and scope of the invention as claimed.

We claim:

1. A method for playing a live game of chance at a gaming table comprising the steps of:
Establishing at least one remote player at said gaming table;
Initializing the play of said game of chance;
Detecting intermediate results of the play of said game of chance by determining the value of at least one gaming object associated with said game of chance;
Soliciting a determination of how to play the game of chance from said remote player;
In response to said determination, completing the play of said game of chance;
Determining the result of the play of said game of chance; and
Based on said result, automatically paying winning wagers and collecting losing wagers from said remote players.

2. The method of claim 1 wherein said soliciting step comprises the steps of:
Transmitting the value of said at least one gaming object to said remote player;
Displaying the value of said at least one gaming object on at least a portion of a display screen of a gaming machine associated with said remote player; and
Transmitting a decision of said remote player regarding said gaming object to said gaming table; and
Communicating said decision to a gaming employee associated with said gaming table,

3. The method of claim 2 further comprising the step of broadcasting an audio/video signal of said gaming table to said remote player for display on said gaming machine in combination with said value.

4. The method of claim 1 wherein said initializing step comprises the steps of:
Distributing at least one gaming object associated with said game of chance; and
Transmitting said value to each remote player.

5. The method of claim 4 wherein said game of chance comprises a card game and said at least one gaming object is selected from a plurality of detectable cards.

6. The method of claim 5 wherein said establishing step further comprises the steps of:
Establishing a communications link between said game table and said remote player, said communications link including a broadcast quality audio/video signal; and
Requesting said remote player to enter a bet to be applied to the next to occur play of the game of chance.

7. A method for playing a card game at a live action game table from a plurality of locations remote from said game table, said method comprising the steps of:
Establishing at least one remote player at a multiple player position, said multiple player position defined on said game table;
Distributing a plurality of encoded cards to said multiple player position;
Detecting the value or each of said plurality of encoded cards;
Transmitting the value to each remote location;
Requesting said at least one remote player to determine how to play the card game;
Receiving said determination from said at least one remote player;
Based on said determinations, distributing additional cards at said multiple player position;
Repeating said requesting, receiving and distributing steps until said at least one remote player makes a final determination;
Assigning said at least one remote player to a class; and
Paying said at least one remote player if assigned to a winning class following completion of said card game.

8. The method of claim 7 further comprising the step of comparing the value of the dealer's cards to the value of said class to determine if said class is a winning class.

9. The method of claim 8 further comprising the steps of:
Establishing a plurality of remote players at said multiple player positions; and
Segregating said players are each of said remote locations into a plurality of classes where each class includes only those players making identical determinations.

10. The method of claim 9 where in said step of establishing a plurality of remote players further comprises the steps of:
Managing the communication link between said multiple player position and each of said plurality of remote players; and
Comparing the values of each class to the value of the dealer's cards to determine if said class is a winning class

11. A system for playing a game of chance from a remote location comprising:
A gaming table having a plurality of defined positions for playing a game of chance;
A plurality of gaming objects;
A plurality of readers, each of said readers positioned proximate to a corresponding one of said defined positions, said readers adapted for detecting the value of at least one of said plurality of gaming objects positioned in the corresponding one of said defined positions;
A table network coupled to said readers;
A network manager;
A table manager coupled to said table network, said table manager having means for determining the value of said gaming object at each of said defined positions;
A communication network coupling said table manager to said network manager so that the value detected by each reader may be transmitted to at least one remote player; and
means, associated with said remote player, for transferring a determination by said remote player to the dealer at said table.

12. The system of claim 11 further comprising a gaming machine associated with said remote player, said gaming machine coupled to said communication network.

13. The system of claim 11 wherein said gaming object comprises a plurality of cards, each of said cards having an embedded circuit programmed with a value, said value capable of being detected by said reader when positioned in said defined position.

14. The system of claim 13 wherein each of said cards comprise pair of layers having a RFID circuit sandwiched therebetween.

15. The system of claim 13 wherein each of said cards comprise a slurry structure having a RFID circuit embedded therein.

16. The system of claim 13 wherein said cards comprise a RFID circuit encoded with a value corresponding to said game of chance, said circuit coupled to an antenna.

17. The system of claim 11 wherein said gaming object comprises a plurality of casino chips, each of said cards having an embedded circuit programmed with a value, said value capable of being detected by said reader when positioned in said defined position.

18. The system of claim 17 wherein each of said casino chips comprise pair of substrates having a RFID circuit sandwiched therebetween.

19. The system of claim 17 further comprising a reader positioned on a detector aid, said detector aid adapted to position a plurality of casino chips thereon and to communicate values to said table manager.

20. The system of claim 11 wherein said gaming object comprises a dice, said dice having six faces, each of said faces having an embedded circuit programmed with a value, said value capable of being detected by said reader when positioned in said defined position.

21. The system of claim 20 wherein each of said dice comprises a cube-like inner portion having a RFID circuit affixed to each face of said inner portion.

22. The system of claim 20 further comprising a reader positioned on a detector aid, said detector aid adapted to detect the orientation of said dice and to communicate values to said table manager.

23. The system of claim 11 wherein said gaming object comprises a plurality of roulette ball having an embedded circuit programmed with a value, said value capable of being detected by said reader when positioned in said defined position.

24. The system of claim 23 further comprises a roulette wheel having a plurality of readers associated with at least every other one of the slots in said roulette wheel.

25. The system of claim 11 wherein said gaming object comprises a circuit programmed with a value corresponding to said game of chance and casino specific information, said value and said information capable of being detected by said reader when positioned in said defined position.

26. The system of claim 11 wherein said gaming object comprises a RFID circuit encoded with a value corresponding to said game of chance coupled to an antenna.

27. In a real-time interactive gaming system having a plurality of live action tables each coupled to a plurality of gaming machines so that remote players may place bets on the game of chance being conducted at said table, said gaming system having at least one camera for transmitting broadcast quality signals of the live action play of the game of chance to each of said gaming machines, said real-time interactive gaming system comprising:
at least one gaming object having a value associated therewith;
detector means associated with said gaming table for detecting the value associated with said gaming device;
a table manager, coupled to said detector means, adapted to transmit the detected values to said gaming machines and for receiving instructions from remote players at said gaming machines; and
a display for displaying said instructions at said table.

28. The real-time interactive gaming system of claim 27 wherein said detector means is proximate to at least one multiple player position, said multiple player position defined on said game table.

29. The real-time interactive gaming system of claim 27 wherein said table manager is further adapted to define a plurality of classes and assigning said remote players to one of said classes and paying said remote player if assigned to a winning class following completion of said card game.

30. The real-time interactive gaming system of claim 29 wherein said table manager is further adapted to segregate said remote players into a plurality of classes where each class includes only those players making identical determinations.

31. The real-time interactive gaming system of claim 27 wherein said table manager comprises:
A first interface means for connecting said table manager to said detector means;
A memory for storing computer program instructions and information relating to the play of the game of chance;
A computer for executing said computer program instructions; and
A second interface for connecting said table manager to a communication network.

32. The real-time interactive gaming system of claim 31 wherein said computer executes said computer program instructions to managing the communication link between said multiple player position and each of said plurality of remote players, and for comparing the values of each class to the value of the dealer's cards to determine if said class is a winning class.

33. The real-time interactive gaming system of claim 27 further comprising means for establishing a player's stake.

34. In a real-time interactive gaming system having a plurality of live action tables each coupled to a plurality of gaming machines so that remote players may place bets on the game of chance being conducted at said table, said gaming system having at least one camera for transmitting broadcast quality signals of the live action play of the game of chance to each of said gaming machines, a gaming object comprising:
a transponder circuit encoded with a value corresponding to said game of chance and coupled to an antenna;
a reader for generating a radio frequency field within a defined area and for detecting said value when said transponder circuit is positioned within said defined area, and
means for embedding said circuit whereby said embedding means enables the play of a game of chance.

35. The real-time interactive gaming system of claim 34 wherein said embedding means comprises a playing card and said value corresponds to the value of the playing card.

36. The real-time interactive gaming system of claim 34 wherein said embedding means comprises a dice and said value corresponds to the number appearing on a face of the dice.

37. The real-time interactive gaming system of claim 34 wherein said embedding means comprises a roulette ball, said value corresponds to an identifying serial number and said defined area comprises the width of one and one-half slots on a roulette wheel.

38. The real-time interactive gaming system of claim 34 wherein said reader further comprises a smart detector aid having a front and a side portion each adapted for mounting a reader thereon.
